(19) United States
(12) Patent Application Publication
(10) Pub. No.: US 2008/0017227 A1
(43) Pub. Date: Jan. 24, 2008

(54) Walking aid apparatus

(76) Inventor: Barry D. Ward, Covington, LA (US)

Correspondence Address: Galasso & Associates, LP, P.O. Box 26503, Austin, TX, 78755-0503, US

(21) Appl. No.: 11/488,964

(22) Filed: Jul. 19, 2006

(51) Int. Cl. A61H 3/00

(52) U.S. Cl. 135/67

(57) ABSTRACT

A walking aid apparatus configured to provide additional horizontal support for a user engaged therewith. The walking aid apparatus comprises a frame that includes four leg members being substantially tubular in shape and hollow. Suspended between the four leg members is a support sling configured to partially or fully support a user engaged with the walking aid. Proximate one end of the four leg members are four adjustable support sling members configured to releasably secure the support sling to the frame. The walking aid further includes a plurality of lateral support members intermediate the four leg members. Contiguously mounted to the leg members distally located from the support sling members are four vertical control members configured to adjust the height of the frame. The frame further has mounted thereon at least two wheels proximate the vertical control members.

### FIELD OF THE INVENTION

The present invention relates to a walking aid apparatus, more specifically but not by way of limitation, to walking aid apparatus configured with a sling configured to receive the user and to facilitate the user with aid in walking and further to provide additional safety and support.

### BACKGROUND

Millions of individuals suffer from illnesses or aging that cause deterioration of muscles and bones resulting in a difficulty of common physical tasks such as walking. In the United States alone, more than ten thousand people a day reach the age of fifty-five years of age. The onset of old age creates symptoms that are enhanced by conditions such as calcium deficiencies, osteoporosis, and arthritis.

During the aging process and the onset of the referenced conditions, individuals can began having difficulty walking. The walking abilities can be greatly reduced and slowed and individuals suffering from a variety of these symptoms whether in combination or by themselves began to develop issues with maintaining balance while being ambulatory. Traditionally, such individuals began to regularly require a walking aid to assist in the process of walking.

One problem with current walking aids is that while they provide a method of assisting the user in walking they do not provide an area in which the user of the walking aid apparatus can rest during the walking process. As users of walking aids usually suffer from muscle atrophy, they routinely need to rest during walking. Additionally, traditional walkers require the user to support themselves with their arms while engaged with the walking aid. As many users of such devices do not have the strength to support themselves for an extended period of time while walking, they are in need of a walking device that can provide adequate support for the user in order to rest or during the walking process.

Accordingly, there is a need for a device that can assist a user in being ambulatory and be able to provide a method for supporting the individual during periods of rest and during the walking process.

### SUMMARY OF THE INVENTION

It is the object of the present invention to provide a walking aid apparatus that includes a method for supporting the user when the user is engaged with the walking aid apparatus.

It is a further object of the present invention to provide a walking aid apparatus that utilizes a sling to provide a suitable support structure for the user when engaged with the walking aid apparatus, and further protects the user from injury by preventing the user from falling during use and thus enables the user to use the walking aid apparatus with little or no assistance.

Another object of the present invention is to provide a walking aid apparatus that is collapsible in order to facilitate easier transportation or storage thereof.

Yet another object of the present invention is to provide a walking aid apparatus that includes a fabric sling horizontal support for a user that is light weight and easy to use.

A further object of the present invention is to provide a walking aid apparatus that provides a user a method of suitable support while engaged with the walking aid apparatus that is adjustable.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawing wherein:

FIG. 1 is a perspective view of an embodiment of the present invention; and

FIG. 2 is a top view of an embodiment of the support sling of the present invention.

### DETAILED DESCRIPTION

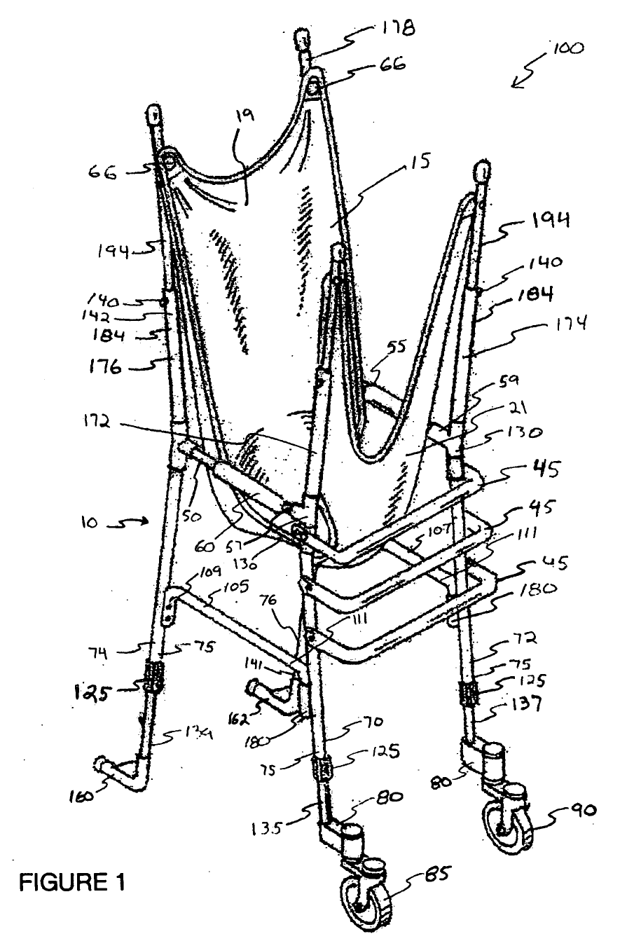

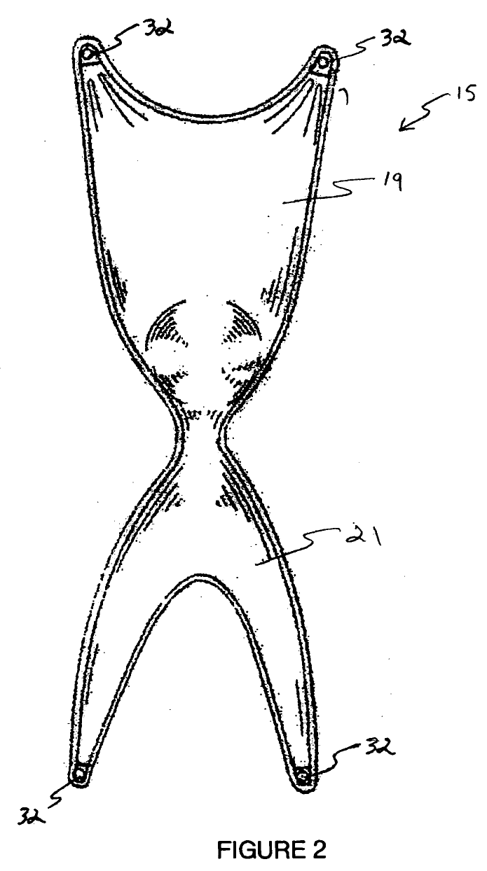

Referring now to the drawings submitted herewith wherein the various elements depicted therein are not necessarily drawn to scale and wherein like elements are identified with like reference numerals and in particular to FIGS. 1 and 2, there is illustrated a preferred embodiment of a walking aid 100.

The walking aid 100 comprises a frame 10 that is manufactured from a suitable durable material such as but not limited to aluminum tubing. Those skilled in the art will recognize that numerous materials could be utilized in order to construct a frame 10 according to the principles of the present invention. The frame 10 includes leg members 70, 72, 74 and 76 that are positioned opposite each other and are substantially vertically oriented in manner during operation of walking aid 100. Leg members 70, 72, 74 and 76 are positioned at opposing corners of the frame 10. Leg members 70, 72, 74, 76 function to provide structural support for the walking aid 100 and are positioned in order facilitate assisting a user balance themselves when engaged with the walking aid 100. Although the walking aid 100 is illustrated in the drawings submitted herewith as having four leg members 70, 72, 74 and 76, those skilled in the art will recognize that the frame 10 could be manufactured with numerous different amount of leg members 70, 72, 74 and 76 configured to provide structural support for the walking aid 100. The leg members 70, 72, 74 and 76 are constructed of a suitable durable hollow material being substantially tubular in shape such as but not limited to aluminum tubing.

Receivably connected to one end 75 of each leg members 70, 72, 74 and 76 are support members 135,137,139,141. The support members 135,137,139,141 are manufactured to be of an appropriate diameter such that the support members 135,137,139,141 are receivable into each of the leg members 70, 72, 74 and 76. The support members 135,137,139,141 are partially disposed within the leg members 70, 72, 74 and 76 and are operable to vary the height of the walking aid 100. The length of support members 135,137,139,141 extending from leg members 70, 72, 74 and 76 can be varied to provide a comfortable height for a user.

Surroundably mounted to the ends 75 of each leg members 70, 72, 74 and 76 are tension collars 125. The tension collars 125 are mechanical fasteners that function to secure the support members 135, 137, 139 and 141 with friction at a desired position within the leg members 70, 72, 74 and 76 thus allowing the user to adjust the height of the walking aid 100.

Perpendicularly secured to each of the support members 135 and 137 and distal to the tension collar 125 are wheel brackets 80. Wheel brackets 80 function to mechanically connect wheels 85 and 90 to support members 135 and 137. Good results have been achieved using rubber swivel caster type wheels for wheels 85 and 90. This facilitates easy maneuvering of the walking aid 100 by a user. Those skilled in the art will recognize that different types and numbers of wheels 85 and 90 could be utilized to assist a user in movement of the walking aid 100.

Contiguously mounted to support members 139 and 141 are rear support members 160 and 162. The rear support members 139 and 141 function to engage the walking surface upon which walking aid 100 is to be used. Rear support members 139 and 141 operate to inhibit the walking aid 100 from becoming unstable and from moving in a generally backward direction with respect to the user that is engaged with the walking aid 100.

Mechanically secured to each leg member 70, 72, 74 and 76 distally located from the support members 135, 137, 139 and 141 are top rail members 50 and 55. The top rail members 50 and 55 are intermediate leg members 70 and 72 and leg members 74 and 76 respectively and are configured in a generally perpendicular manner with the leg members 70, 72, 74 and 76 and are further parallel with respect to each other. The top rail members 50 and 55 are manufactured from a suitable durable material such as aluminum tubing and are secured to the leg members 70, 72, 74 and 76 by conventional mechanical methods.

The top rail members 50 and 55 function as an interface for the user that is engaged with the walking aid 100. The top rail members 50 and 55 further function to increase the structural rigidity of the frame 10. Surroundably mounted to the top rail members 50 and 55 are grips 60. Grips 60 function to increase the comfort of the user subsequent to engagement with top rail members 50 and 55 and are manufactured with a durable and soft material such as but not limited to foam rubber.

The ends 57 and 59 of the top rail members 50 and 55 are secured to the leg members 70 and 72 with hinge connectors 130. The hinge connectors 130 function to allow the leg members 70 and 72 to be collapsed or folded towards leg members 74 and 76 in order to facilitate easier storage or transportation of the walking aid 100. Those skilled in the art will recognize that numerous different types of mechanical fasteners could be utilized to manufacture the hinge connections 130 and perform the desired function as described herein.

Side support members 105 and 107 are positioned below top rail members 50 and 55, respectively, with support member 105 positioned intermediate legs 70 and 74 and support member 107 is positioned intermediate legs 72 and 76. The side support members 105 and 107 are manufactured from a durable suitable material such as but not limited too aluminum tubing. Each of side support members 105 and 107 are secured to the corresponding leg members by conventional mechanical methods such as screws 109.

Each of side support member 105 and 107 are connected to leg members 70 and 72 respectively with hinges 180. Hinge connectors 180 function to hingeably secure the ends 111 of the side support members 105 and 107 to the leg members 70 and 72 permitting the leg members 70 and 72 to be moved proximate the leg members 74 and 76 in order to facilitate the folding of walking aid 100. Those skilled in the art will recognize that numerous different types of mechanical fasteners could be utilized for hinge connectors 180.

Proximate the top rail members 50 and 55 and superposed on each leg member 70, 72, 74 and 76 extending in an upward direction are the sling support members 172, 174, 176 and 178. The sling support members 172, 174, 176 and 178 are configured to have a first portion 184 and a second portion 194. The first portion 184 is proximate the leg members 70, 72, 74 and 76 and are generally round in shape and are substantially hollow being configured to mateably receive therein the second portion 194. The second portion 194 is manufactured to be of an appropriate diameter such that the second portion 194 is slidably received into the first portion 184. The second portion 194 is releasably secured to the first portion 184 with a keeper 140 that is located on one end 142 of each of the sling support members 172, 174, 176 and 178. Those skilled in the art will recognize that numerous different types of mechanical fasteners could be utilized to manufacture the keeper 140 such as but not limited to a spring pin. Although no specific length of the sling support members 172, 174, 176 and 178 is required, good results have been achieved with sling support members 172, 174 176 and 178 that are adjustable between approximately twenty-four to thirty inches in length.

Secured to each end 90 of the second portions 194 of the sling support members 172, 174, 176 and 178 are hooks 66. The hooks 66 are designed to interface with each aperture 32 of the sling 15 in order to releasably secure the sling to the frame 10. The hooks 66 are manufactured from a suitable, durable material such as but not limited to aluminum and is secured to the second portion 194 through conventional methods such as but not limited to welding.

Interposed the leg members 70 and 72 are a plurality of lateral support members 45. The lateral support members 45 are secured to the leg members 70 and 72 by suitable mechanical methods such as but not limited to screws. The lateral support members 45 are manufactured from a suitable and durable material such as but not limited to aluminum tubing. The lateral support members 45 are generally perpendicular with respect to the leg members 70, 72 and function to provide structural support for the frame 10. Although the lateral support members 45 are illustrated in the drawings submitted herewith as generally u-shaped tubular bars, those skilled in the art will recognize that the lateral support members 45 could be numerous different shapes and provide the desired functionality as described herein. While in the drawings submitted herewith, the walking aid 100 is illustrated as having three lateral support members 45, it is further contemplated within the scope of the present invention that many different amounts of the lateral support members 45 could be utilized. More specifically but not by way of limitation, one lateral support member 45 could be utilized in order to provide structural support for the frame 10.

Suspended from the hooks 66 and generally positioned within the frame 10 is the sling 15. As shown in FIG. 2, the sling 15 has a plurality of apertures 32 that are positioned at the ends of sling 15. Apertures 32 facilitate the receipt of hooks 66 in order to releasably secure the sling 15 to the second portion 194 of the sling support members 172, 174, 176 and 178. The sling 15 is manufactured from a durable flexible material such as polyester or cotton. The sling 15 functions to provide the user engaged with the walking aid 100 a suitable support structure to provide full or partial support for the user when utilizing the walking aid 100 by being substantially disposed beneath the user when the user is engaged with the walking aid.

The sling 15 has a rear portion 19 that extends proximate the hooks 66 located on the second portion 194 of the sling support members 176 and 178. This configuration is designed to inhibit a user from falling backward while using the walking aid 100. A front portion 21 of the sling 15 is secured to sling support members 172 and 174 and is structured such that it is smaller in size compared to the rear portion 19. While the sling 15 is illustrated as being a particular shape in the drawings submitted herewith, those skilled in the art will recognize that the sling 15 could be manufactured in numerous different shapes. It is further contemplated within the scope of the present invention that the sling 15 further includes padding in the area that engages with the groin of the user to increase the comfort while engaged with the walking aid 100.

Referring to FIGS. 1 and 2, a description of the operation of the walking aid is as follows. In use, a user will position themselves intermediate the leg members 70,72,74, 76 and engage the top rail members 50 and 55 for support. The user then secures the rear section 19 of the sling 15 to the hooks located on the sling support members 176 and 178. Passing the sling 15 between their legs, the user will then secure the remaining apertures 32 to the hooks 66 to releasably secure the sling 15 to the sling support members 172 and 174.

Subsequent to securing the sling 15 to the sling support members 172, 174, 176 and 178, the user can then adjust the height of the sling support members 172, 174, 176 and 178 to position the sling 15 in the desired location in order to provide the user full or partial support. The user then utilizes the walking aid 100 to traverse the path. To disengage with the walking aid 100, the user will release hooks 66 from the apertures 32 and remove the sling 15 from the frame 10 allowing the user to exit the frame 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A walking aid comprising:
a frame, said frame further including a plurality of leg members; and
a support releasably connected to said frame, said support further positionable about a user and extending from the front of the user, between the users legs, and to the back of the user.

2. The walking aid as recited in claim 1, wherein said frame includes a plurality of upright support members, with portions of said support releasably connected to each of said plurality of upright support members.

3. The walking aid as recited in claim 2, wherein said support includes a first portion and a second portion and further wherein said support is tapered intermediate said first portion and said second portion.

4. The walking aid as recited in claim 3, wherein said frame further includes a plurality of vertical control members, said vertical control members being distal said adjustable members, said vertical control members having a portion thereof disposed within said leg members, said vertical control members configured to control the height of said frame.

5. The walking aid as recited in claim 4, wherein said frame is operable to be configured in at least one of a folded position and an open position.

6. The walking aid as recited in claim 5, and further including a plurality of wheels, with at least a first and a second of said plurality of wheels connected to a first and a second of said plurality of leg members.

7. The walking aid as recited in claim 6, wherein said frame further includes a plurality of lateral support members, said lateral support members for providing structural support for said frame.

8. A walking aid configured to assist a user by providing body support comprising:
a frame, said frame further including a plurality of leg members, said leg members having a first end and a second end, said leg members being generally tubular in shape and substantially hollow; and
a body support, said body support suspended substantially within said frame, said body support being positionable with at least a portion underneath an individual, said body support configured to provide at least partial support for an individual engaged with said walking aid.

9. The walking aid as recited in claim 8, and further including a plurality of adjustable support members proximate said first end of said leg members, said adjustable support members being configured to releasably secure said body support to said frame.

10. The walking aid as recited in claim 9, wherein said body support has a first and a second portion, and further wherein said body support tapers intermediate said first and second portions.

11. The walking aid as recited in claim 10, and further including a plurality of hooks, with each of said hooks secured to said adjustable support members, said hooks for releasably securing said body support to said frame.

12. The walking aid as recited in claim 11, and further including a plurality of vertical support members, said vertical support members being proximate said second end of said leg members, said vertical support members being partially disposed within said leg members, said vertical support members operable to vary the height of said frame.

13. The walking aid as recited in claim 12, wherein said is foldable.

14. The walking aid as recited in claim 13, wherein said adjustable support members are operable to vary from twenty-four to thirty inches in length.

15. A walking aid configured to assist a user by providing additional support comprising:
a frame, said frame further including four leg members, said four leg members having a first end and a second end, said four leg members being generally tubular in shape and substantially hollow, said frame further including at least one lateral support member intermediate said four leg members; and
a support sling, said support sling suspended substantially within said frame, said support sling being substantially underneath an individual engaged with said walking aid, said support sling configured to provide partial or full support for an individual engaged with said walking aid.

16. The walking aid as recited in claim 15, and further including four support sling members, said four support sling members proximate said first end of said four leg members, said four support sling members being configured to releasably secure said support sling to said frame, said four support sling members having a first end and a second end, said first end of said four support sling members being partially disposed within said four leg members, said four support sling members being adjustable.

17. The walking aid as recited in claim 16, wherein said support sling further includes a first section and a second section, said second section being configured to inhibit a user of said walking aid from falling backwards.

18. The walking aid as recited in claim 17, and further including four vertical support members, said four vertical support members being proximate said second end of said four leg members, said four vertical support members having a first end and a second end, said first end of said four vertical support members being partially disposed within said four leg members, said four vertical support members for controlling the height of said frame.

19. The walking aid as recited in claim 18, wherein said support sling has circumferentially disposed thereon four apertures, said apertures for securing said support sling to said second end of said four support sling members.

20. The walking aid as recited in claim 19, and further including one hook proximate the second end of said four support sling members, said hook configured to journal therethrough said aperture of said support sling, said hook for releasably securing said support sling to said frame.
